(19) United States
(12) Patent Application Publication
(10) Pub. No.: US 2022/0138658 A1
(43) Pub. Date: May 5, 2022

(54) AUTOMATED SELECTION OF VEHICLE REPAIRS FOR REINSPECTION

(71) Applicant: Mitchell International, Inc., San Diego, CA (US)

(72) Inventors: Vinod Yachareni, San Diego, CA (US); Ravi Kandukuri, San Diego, CA (US); Miguel Koropecky, San Diego, CA (US); Krupal Mistry, San Diego, CA (US)

(73) Assignee: Mitchell International, Inc., San Diego, CA (US)

(21) Appl. No.: 17/088,374

(22) Filed: Nov. 3, 2020

(51) Int. Cl. G06Q 10/06; G06Q 10/00

(52) U.S. Cl. CPC G06Q 10/06393; G06Q 10/20; G06Q 10/06395

(57) ABSTRACT

Systems, non-transitory machine-readable storage media, and computer-implemented methods are provided for automated selection of vehicle repairs for reinspection. In general, one aspect disclosed features a computer-implemented method comprising: receiving a notification that a vehicle repair estimate for a vehicle has been submitted by a vehicle repair facility; responsive to receiving the notification, determining whether the vehicle repair facility has satisfied a quantitative vehicle repair re-inspection benchmark; responsive to determining the vehicle repair facility has not satisfied the vehicle repair re-inspection benchmark, determining whether the vehicle repair facility has satisfied a temporal vehicle repair benchmark for repair of the vehicle; and responsive to determining the vehicle repair facility has satisfied the temporal vehicle repair benchmark for repair of the vehicle, initiating a re-inspection of the vehicle.

### CROSS REFERENCE TO RELATED APPLICATIONS

The present application is related to U.S. patent application Ser. No. 17/088,341, filed on Nov. 3, 2020, entitled “AUTOMATED SCHEDULING OF VEHICLE REPAIR REINSPECTIONS” [Attorney Docket No.: MITCH-APD-00039 (13CN-312236)], the disclosure thereof incorporated by reference herein in its entirety.

### BACKGROUND

The disclosed technology relates generally to systems for vehicle repair workflows, and more particularly, some embodiments relate to automation of those workflows.

### SUMMARY

A claimed solution rooted in computer technology overcomes problems specifically arising in the realm of computer technology.

In general, one aspect disclosed features a system, comprising: a hardware processor; and a non-transitory machine-readable storage medium encoded with instructions executable by the hardware processor to perform a method comprising: receiving a notification that a vehicle repair estimate for a vehicle has been submitted by a vehicle repair facility; responsive to receiving the notification, determining whether the vehicle repair facility has satisfied a quantitative vehicle repair re-inspection benchmark; responsive to determining the vehicle repair facility has not satisfied the vehicle repair re-inspection benchmark, determining whether the vehicle repair facility has satisfied a temporal vehicle repair benchmark for repair of the vehicle; and responsive to determining the vehicle repair facility has satisfied the temporal vehicle repair benchmark for repair of the vehicle, initiating a re-inspection of the vehicle.

Embodiments of the system may include one or more of the following features. In some embodiments, determining whether the vehicle repair facility has satisfied a quantitative vehicle repair re-inspection benchmark further comprises: determining a re-inspection current percentage of vehicles repaired by the repair facility that have been re-inspected, wherein the vehicle repair re-inspection benchmark comprises a re-inspection benchmark percentage; comparing the re-inspection current percentage with the re-inspection benchmark percentage; and determining whether the vehicle repair facility has satisfied the vehicle repair re-inspection benchmark based on the comparing. In some embodiments, determining whether the vehicle repair facility has satisfied the quantitative vehicle repair re-inspection benchmark based on the comparing comprises: determining the vehicle repair facility has not satisfied the vehicle repair re-inspection benchmark when the re-inspection current percentage does not exceed the re-inspection benchmark percentage; and determining the vehicle repair facility has satisfied the vehicle repair re-inspection benchmark when the re-inspection current percentage exceeds the re-inspection benchmark percentage. In some embodiments, determining whether the vehicle repair facility has satisfied a temporal vehicle repair benchmark for repair of the vehicle comprises: determining whether the vehicle has been at the vehicle repair facility for more than a first threshold time period, and/or determining whether the vehicle has been under repair at the vehicle repair facility for more than a second threshold time period; and determining the temporal vehicle repair benchmark has been satisfied responsive to determining that the vehicle has been at the vehicle repair facility for more than the first threshold time period and/or determining that the vehicle has been under repair at the vehicle repair facility for more than the second threshold time period. In some embodiments, the method further comprises: responsive to receiving the notification, decreasing the re-inspection current percentage. In some embodiments, the method further comprises: responsive to a re-inspection of the vehicle being completed, increasing the re-inspection current percentage. In some embodiments, the method further comprises: determining whether the vehicle repair facility is within a region subject to re-inspection; and responsive to the vehicle repair facility not being within a region subject to re-inspection, taking no action.

In general, one aspect disclosed features a non-transitory machine-readable storage medium encoded with instructions executable by a hardware processor of a computing component, the machine-readable storage medium comprising instructions to cause the hardware processor to perform a method comprising: receiving a notification that a vehicle repair estimate for a vehicle has been submitted by a vehicle repair facility; responsive to receiving the notification, determining whether the vehicle repair facility has satisfied a quantitative vehicle repair re-inspection benchmark; responsive to determining the vehicle repair facility has not satisfied the vehicle repair re-inspection benchmark, determining whether the vehicle repair facility has satisfied a temporal vehicle repair benchmark for repair of the vehicle; and responsive to determining the vehicle repair facility has satisfied the temporal vehicle repair benchmark for repair of the vehicle, initiating a re-inspection of the vehicle.

Embodiments of the non-transitory machine-readable storage medium may include one or more of the following features. In some embodiments, determining whether the vehicle repair facility has satisfied a quantitative vehicle repair re-inspection benchmark further comprises: determining a re-inspection current percentage of vehicles repaired by the repair facility that have been re-inspected, wherein the vehicle repair re-inspection benchmark comprises a re-inspection benchmark percentage; comparing the re-inspection current percentage with the re-inspection benchmark percentage; and determining whether the vehicle repair facility has satisfied the vehicle repair re-inspection benchmark based on the comparing. In some embodiments, determining whether the vehicle repair facility has satisfied the quantitative vehicle repair re-inspection benchmark based on the comparing comprises: determining the vehicle repair facility has not satisfied the vehicle repair re-inspection benchmark when the re-inspection current percentage does not exceed the re-inspection benchmark percentage; and determining the vehicle repair facility has satisfied the vehicle repair re-inspection benchmark when the re-inspection current percentage exceeds the re-inspection benchmark percentage. In some embodiments, determining whether the vehicle repair facility has satisfied a temporal vehicle repair benchmark for repair of the vehicle comprises: determining whether the vehicle has been at the vehicle repair facility for more than a first threshold time period, and/or determining whether the vehicle has been under repair at the vehicle repair facility for more than a second threshold time period; and determining the temporal vehicle repair benchmark has been satisfied responsive to determining that the vehicle has been at the vehicle repair facility for more than the first threshold time period and/or determining that the vehicle has been under repair at the vehicle repair facility for more than the second threshold time period. In some embodiments, the method further comprises: responsive to receiving the notification, decreasing the re-inspection current percentage. In some embodiments, the method further comprises: responsive to a re-inspection of the vehicle being completed, increasing the re-inspection current percentage. In some embodiments, the method further comprises: determining whether the vehicle repair facility is within a region subject to re-inspection; and responsive to the vehicle repair facility not being within a region subject to re-inspection, taking no action.

In general, one aspect disclosed features a computer-implemented method comprising: receiving a notification that a vehicle repair estimate for a vehicle has been submitted by a vehicle repair facility; responsive to receiving the notification, determining whether the vehicle repair facility has satisfied a quantitative vehicle repair re-inspection benchmark; responsive to determining the vehicle repair facility has not satisfied the vehicle repair re-inspection benchmark, determining whether the vehicle repair facility has satisfied a temporal vehicle repair benchmark for repair of the vehicle; and responsive to determining the vehicle repair facility has satisfied the temporal vehicle repair benchmark for repair of the vehicle, initiating a re-inspection of the vehicle.

Embodiments of the computer-implemented method may include one or more of the following features. In some embodiments, determining whether the vehicle repair facility has satisfied a quantitative vehicle repair re-inspection benchmark further comprises: determining a re-inspection current percentage of vehicles repaired by the repair facility that have been re-inspected, wherein the vehicle repair re-inspection benchmark comprises a re-inspection benchmark percentage; comparing the re-inspection current percentage with the re-inspection benchmark percentage; and determining whether the vehicle repair facility has satisfied the vehicle repair re-inspection benchmark based on the comparing. In some embodiments, determining whether the vehicle repair facility has satisfied the quantitative vehicle repair re-inspection benchmark based on the comparing comprises: determining the vehicle repair facility has not satisfied the vehicle repair re-inspection benchmark when the re-inspection current percentage does not exceed the re-inspection benchmark percentage; and determining the vehicle repair facility has satisfied the vehicle repair re-inspection benchmark when the re-inspection current percentage exceeds the re-inspection benchmark percentage. In some embodiments, determining whether the vehicle repair facility has satisfied a temporal vehicle repair benchmark for repair of the vehicle comprises: determining whether the vehicle has been at the vehicle repair facility for more than a first threshold time period, and/or determining whether the vehicle has been under repair at the vehicle repair facility for more than a second threshold time period; and determining the temporal vehicle repair benchmark has been satisfied responsive to determining that the vehicle has been at the vehicle repair facility for more than the first threshold time period and/or determining that the vehicle has been under repair at the vehicle repair facility for more than the second threshold time period. Some embodiments comprise responsive to receiving the notification, decreasing the re-inspection current percentage. Some embodiments comprise responsive to a re-inspection of the vehicle being completed, increasing the re-inspection current percentage.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates a vehicle repair reinspection system according to some embodiments of the disclosed technology.

FIG. 2 illustrates a process for vehicle repair workflow according to some embodiments of the disclosed technology.

FIG. 3 illustrates a process for an automated selection of vehicle repairs for reinspection according to some embodiments of the disclosed technology.

FIG. 4 illustrates a process for determining whether a vehicle repair facility has satisfied a quantitative vehicle repair reinspection benchmark according to some embodiments of the disclosed technology.

FIG. 5 illustrates a process for determining whether the vehicle repair facility has satisfied a temporal vehicle repair benchmark for repair of the vehicle according to some embodiments of the disclosed technology.

FIG. 6 illustrates a process for tracking and modifying an estimate count and a reinspection benchmark percentage according to some embodiments of the disclosed technology.

FIG. 7 illustrates a process for tracking and modifying an completed reinspection count and a reinspection benchmark percentage according to some embodiments of the disclosed technology.

FIGS. 8A,B,C illustrate an example record that may be maintained for a vehicle repair facility according to some embodiments of the disclosed technology.

FIGS. 9A,B,C illustrate an example user interface enabling a user to configure the rules for the process of FIG. 5.

10 is an example computing component that may be used to implement various features of embodiments described in the present disclosure.

The figures are not exhaustive and do not limit the present disclosure to the precise form disclosed.

### DETAILED DESCRIPTION

Safe and proper vehicle collision repairs are priorities for insurance carriers and their policy holders. To ensure that vehicle repairs are done with the highest quality, insurance carriers want to physically inspect the vehicle prior to and/or during the repair process; this process is known as a “Reinspection”. If problems are found during reinspection, the carrier can work with the repair facility to correct the problems before the vehicle is returned to the customer. This process also enables the carrier to work proactively with the repair facility on their quality processes to help prevent problems in the future.

One problem that arises with re-inspections is how to decide which repairs should be reinspected. Ideally, the insurance carrier would re-inspect every repair. But this approach is cost-prohibitive because it would require the carrier to employ a vast number of appraisers to perform the reinspections. An alternative approach is to randomly select a sampling of the repairs for reinspection. This approach allows carriers to conduct the reinspections with a much more reasonably-sized workforce, but introduces the problem that the selection of repairs for reinspection is not based on any sort of quality metric, thereby allowing many quality issues to slip through the process.

Before describing embodiments of the disclosed technology in detail, it is useful to describe an example environment in which the disclosed technology may be implemented.

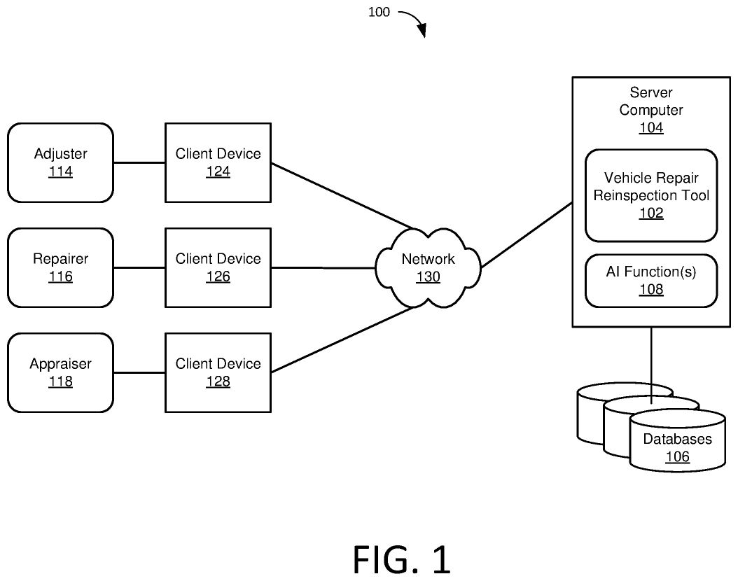

FIG. 1 illustrates a vehicle repair reinspection system 100 according to some embodiments of the disclosed technology. Multiple users may be involved in the vehicle repair workflow. For example, referring to FIG. 1, the users may include a claims adjuster 114, a repairer 116 such as an employee of a repair facility, an appraiser 118, and the like. Each user may employ a respective client device 124, 126, 128. Each client device may be implemented as a desktop computer, laptop computer, smart phone, smart glasses, embedded computers and displays, diagnostic devices and the like.

The system 100 may include a vehicle repair reinspection tool 102, which may be implemented as one or more software packages executing on one or more server computers 104. Each user may employ a respective client device 124, 126, 128 to access the tool 102 over a network 130 such as the Internet.

The tool 102 may include a plurality of Al functions 108. The Al functions 108 may be implemented in any manner. For example, one or more of the Al functions 108 may be implemented as trained machine learning models. The machine learning models may include computer vision machine learning models, natural language processing machine learning models, and the like.

The system 100 may include one or more databases 106. The databases 106 may store one or more configuration rules for selecting vehicle repairs for reinspection, as described in detail herein.

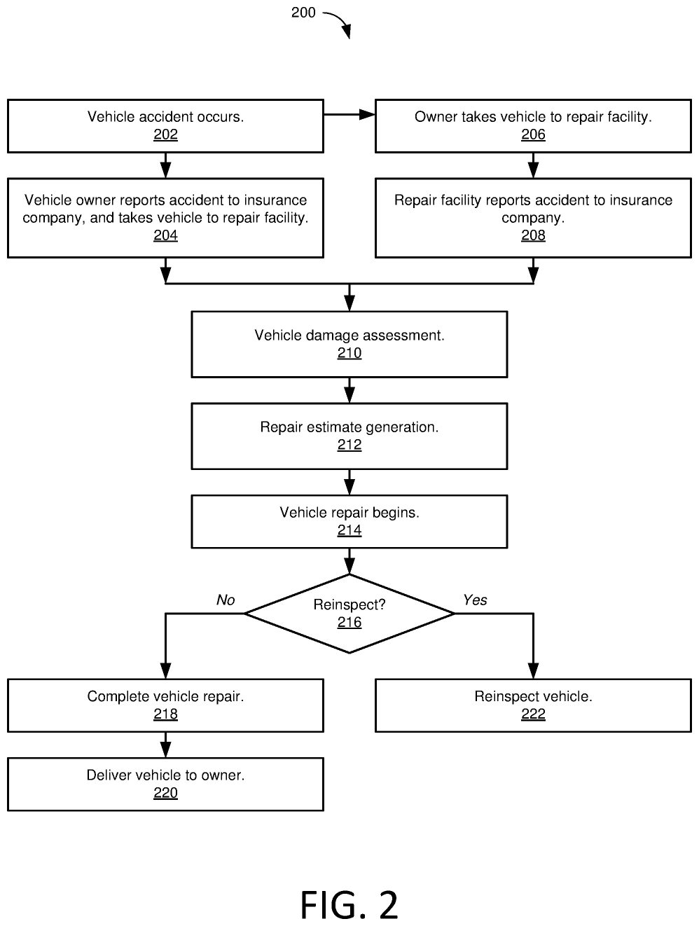

FIG. 2 illustrates a process 200 for vehicle repair workflow according to some embodiments of the disclosed technology. The elements of the disclosed processes are presented in a particular order. However, it should be understood that, in various embodiments, one or more elements may be performed in a different order, in parallel, or omitted. Portions of the disclosed processes may be performed using artificial intelligence functions. For example, referring again to FIG. 1, these portions may be performed by Al functions 108.

Referring to FIG. 2, the process 200 may begin with a vehicle accident, at 202, and may continue with the vehicle owner reporting the accident to an insurance company, and taking the vehicle to a repair facility, at 204. Alternatively, the owner may take the vehicle to a repair facility, at 206, which may report the accident to the insurance company, at 208.

Next, a vehicle damage assessment is performed, at 210. For example, a staff appraiser of an insurance company may visit the damaged vehicle to take photos of the damage. Alternatively, the owner may send photos of the damaged vehicle to the insurance company. Next, the process may include the generation of a vehicle repair estimate, at 212. Based on the vehicle repair estimate, the repair of the vehicle may begin, at 214.

Before or during the repair, the vehicle repair reinspection tool 102 may make a decision to reinspect the vehicle and/or vehicle repair, at 216, as described in detail herein. When a decision is made not to reinspect, the vehicle repair may be completed, at 218. When the repair is complete, the repaired vehicle may be delivered to the vehicle owner, at 220.

When a decision is made to reinspect, the vehicle may be reinspected, at 222. For example, the insurance carrier may dispatch an appraiser to the repair facility to reinspect the vehicle. When a problem is discovered during reinspection, the insurance carrier may help the repair facility remedy the problem, for example by revising the repair estimate, ordering further repairs, modifying the facilities repair, estimate, and quality processes, and the like.

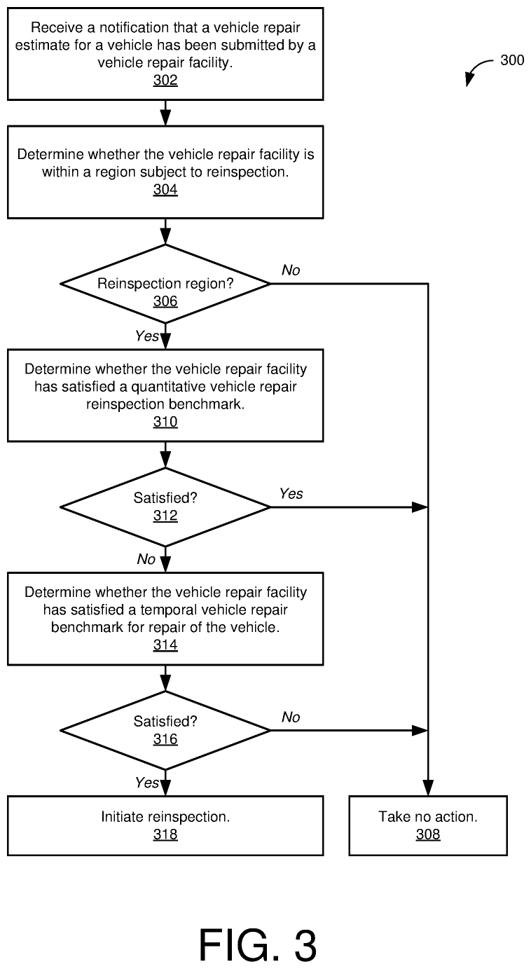

FIG. 3 illustrates a process 300 for an automated selection of vehicle repairs for reinspection according to some embodiments of the disclosed technology. The process 300 may be performed, entirely or in part, by the vehicle repair reinspection tool 102 of FIG. 1.

In the described embodiments, the process 300 is configurable. That is, the process may operate according to rules and parameters that may be configured by a user. For example, referring again to FIG. 1, the user may be an adjuster 114 of an insurance carrier. The adjuster 114 may employ the client device 124 to access the vehicle repair reinspection tool 102, and to control the tool 102 to select one or more rules, and one or more parameters for the rules, to configure the process 300. In this description, certain rules and parameters are described. For example, process 300 may employ one or more quantitative rules, one or more temporal rules, and the like. However, it should be understood that the system may be configured with other rules and parameters. It should also be understood that the rules and parameters may be combined in different logical combinations, for example such as logical AND, OR, AND/OR, XOR, and the like.

Referring to FIG. 3, the process 300 may begin with receiving a notification that a vehicle repair estimate for a vehicle has been submitted by a vehicle repair facility, at 302. For example, referring again to FIG. 1, the vehicle repair reinspection tool 102 may receive the notification. The tool 102 may receive additional information regarding the vehicle repair as well. For example, the tool 102 may receive information describing the length of time the vehicle has been at the vehicle repair facility, the length of time the vehicle has been under repair, and the like. In some embodiments, the tool 102 may receive the vehicle repair estimate, which may serve as the notification.

Referring again to FIG. 3, the process 300 may include determining whether the vehicle repair facility is within a region subject to reinspection, at 304. In some embodiments, reinspection will be performed only when the vehicle repair facility is within designated regions, zones, and the like. Responsive to determining that the vehicle repair facility is not within a reinspection region, at 306, the process 300 may include taking no further action, at 308.

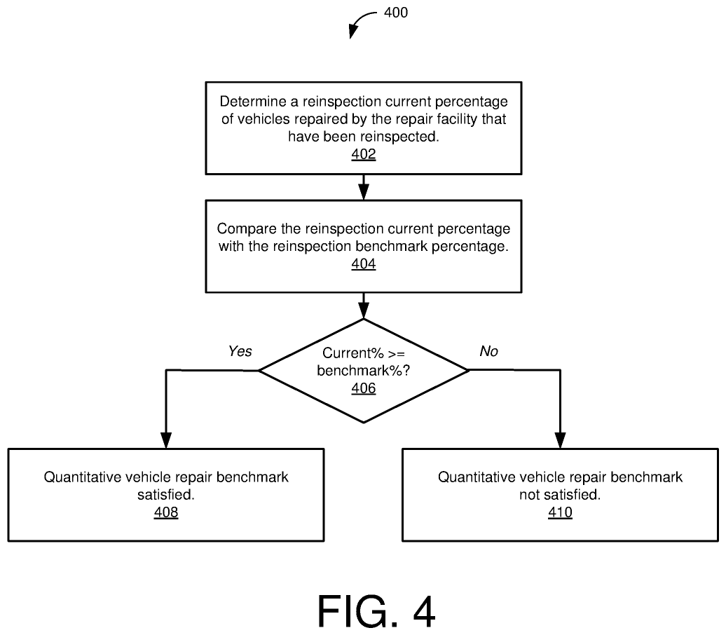

On the other hand, responsive to determining that the vehicle repair facility is within a reinspection region, at 306, the process 300 may include determining whether the vehicle repair facility has satisfied a quantitative vehicle repair reinspection benchmark, at 310, as described in detail herein, for example with reference to FIG. 4. Responsive to determining that the vehicle repair facility has satisfied the quantitative vehicle repair reinspection benchmark, at 312, the process 300 may include taking no further action, at 308.

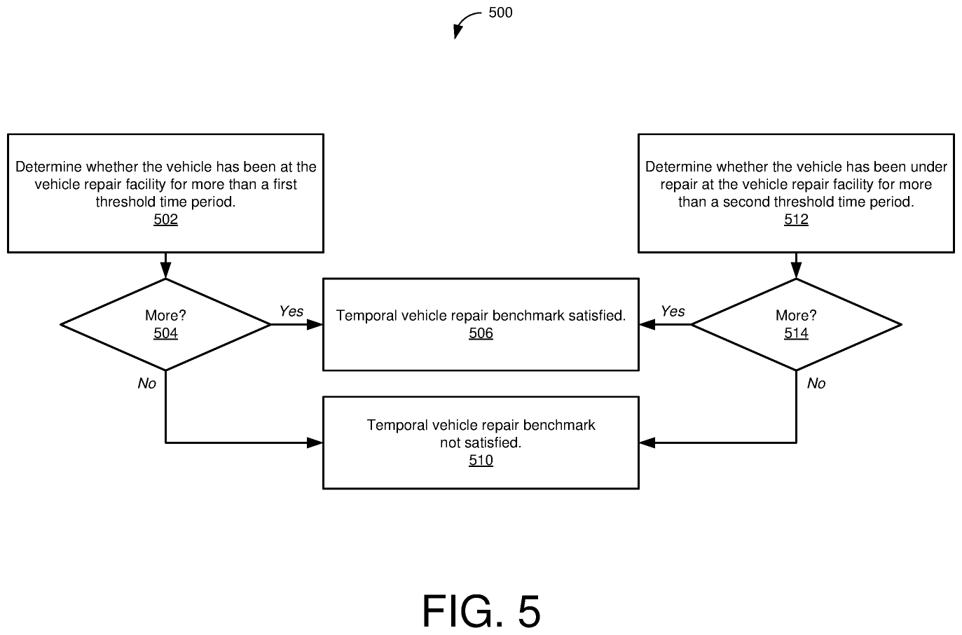

On the other hand, responsive to determining that the vehicle repair facility has not satisfied the quantitative vehicle repair reinspection benchmark, at 312, the process may include determining whether the vehicle repair facility has satisfied a temporal vehicle repair benchmark for repair of the vehicle, at 314, as described in detail herein, for example with reference to FIG. 5. Responsive to determining that the vehicle repair facility has not satisfied the temporal vehicle repair reinspection benchmark, at 316, the process 300 may include taking no further action, at 308.

On the other hand, responsive to determining that the vehicle repair facility has satisfied the temporal vehicle repair benchmark for repair the vehicle, at 316, the process 300 may include initiating reinspection, at 318. Initiating reinspection may include a number of steps such as scheduling the reinspection, selecting an appraiser for the reinspection, contacting the vehicle repair facility, contacting the vehicle owner, and the like, for example as described in the related application cited above.

FIG. 4 illustrates a process 400 for determining whether a vehicle repair facility has satisfied a quantitative vehicle repair reinspection benchmark according to some embodiments of the disclosed technology. The process 400 may be performed, entirely or in part, by the vehicle repair reinspection tool 102 of FIG. 1.

Referring to FIG. 4, the process 400 may include determining a reinspection current percentage of vehicles repaired by the repair facility that have been reinspected, at 402. For example, the vehicle repair reinspection tool 102 may maintain records that reflect a count of the vehicles repaired by the repair facility and a count of the vehicles reinspected at the repair facility, and may divide the count of vehicles reinspected by the count of vehicles repaired to determine a percentage of the vehicles repaired by the repair facility that have been reinspected. In some embodiments, these counts and percentages reflect all repairs and reinspections for the repair facility. In some embodiments, these counts and percentages are limited to repairs and reinspections for a particular insurance carrier.

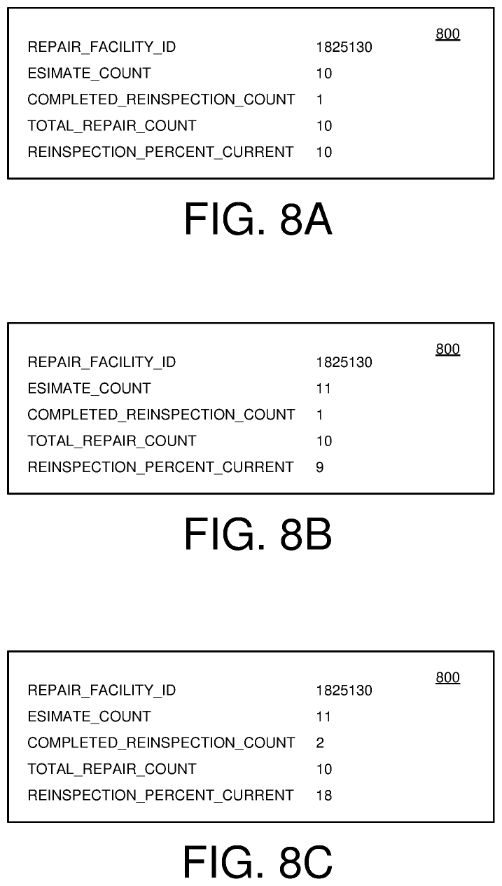

FIGS. 8A,B,C illustrate an example record 800 that may be maintained for a vehicle repair facility according to some embodiments of the disclosed technology. For example, the example record 800 may be stored in the databases 106 of the vehicle repair reinspection system 100 of FIG. 1. Referring to FIG. 8A, example record 800 includes an identifier of the vehicle repair facility (REPAIR_FACILITY_ID=1825130). The example record 800 also includes a count of the vehicle repair estimates submitted by the repair facility (ESTIMATE_COUNT=10). The example record 800 also includes a count of the vehicles reinspected at the repair facility (COMPLETED_REINSPECTION_COUNT=1). The example record 800 also includes a count of the vehicles repairs conducted by the repair facility (TOTAL_REPAIR_COUNT=10). The example record 800 also includes a percentage of the vehicles repaired by the repair facility that have been reinspected (ESTIMATE_PERCENT_CURRENT=10).

Referring again to FIG. 4, responsive to the reinspection current percentage exceeding the reinspection benchmark percentage (Current %>=benchmark %), at 406, the process 400 may determine that the quantitative vehicle repair benchmark has been satisfied, at 408. Responsive to the reinspection current percentage not exceeding the reinspection benchmark percentage, at 406, the process 400 may determine that the quantitative vehicle repair benchmark is not been satisfied, at 410.

FIG. 5 illustrates a process 500 for determining whether the vehicle repair facility has satisfied a temporal vehicle repair benchmark for repair of the vehicle according to some embodiments of the disclosed technology. The process 500 may be performed, entirely or in part, by the vehicle repair reinspection tool 102 of FIG. 1.

Referring to FIG. 5, the process 500 may include determining whether the vehicle has been at the vehicle repair facility for more than a first threshold time period, at 502. The first threshold time period may be specified as a number of days, hours, or the like. Responsive to determining that the vehicle has been at the vehicle repair facility for more than the first threshold time period, at 504, the process 500 may include determining that the temporal vehicle repair benchmark has been satisfied, at 506.

On the other hand, responsive to determining that the vehicle has not been at the vehicle repair facility for more than the first threshold time period, at 504, the process 500 may include determining that the temporal vehicle repair benchmark has not been satisfied, at 510. This rule implements a policy that, if the vehicle has been at the repair shop for a long time, a reinspection is warranted. Insurance carriers know that if a vehicle has been sitting at a repair facility for many days, the repair is typically a complex repair and represents a quality risk. For example, a carrier may determine by analyzing their data, that when a vehicle has been sitting at a repair facility for 6 days or more, they experience more quality issues with those repairs, and may therefore set the first threshold time period at 5 days.

Referring to FIG. 5, the process 500 may include determining whether the vehicle has been under repair at the vehicle repair facility for more than a second threshold time period, at 512. Responsive to determining that the vehicle has been under repair at the vehicle repair facility for more than the second threshold time period, at 514, the process 500 may include determining that the temporal vehicle repair benchmark is satisfied, at 506.

On the other hand, responsive to determining that the vehicle has not been under repair at the vehicle repair facility for more than the second threshold time period, at 514, the process 500 may include determining that the temporal vehicle repair benchmark has not been satisfied, at 510. This rule implements a policy that, if the vehicle has been under repair at the repair shop for a long time, a reinspection is warranted. Insurance carriers know that if a vehicle has been under repair at a repair facility for many days, the repair is typically a complex repair and represents a quality risk. For example, a carrier may determine by analyzing their data, that when a vehicle has been under repair for 4 days or more, they experience more quality issues with those repairs, and may therefore set the first threshold time period at 3 days.

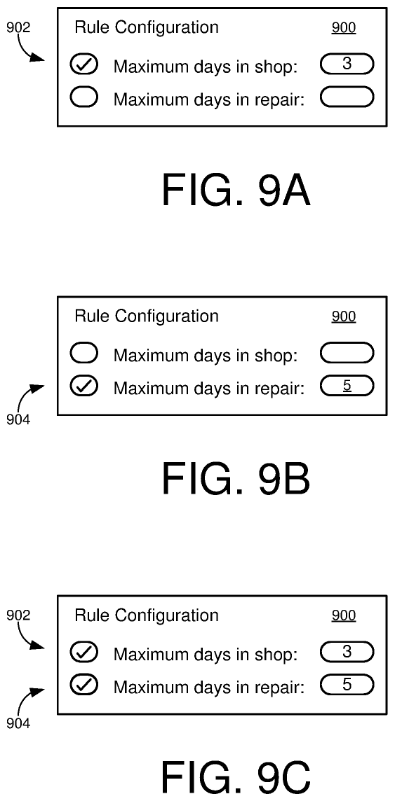

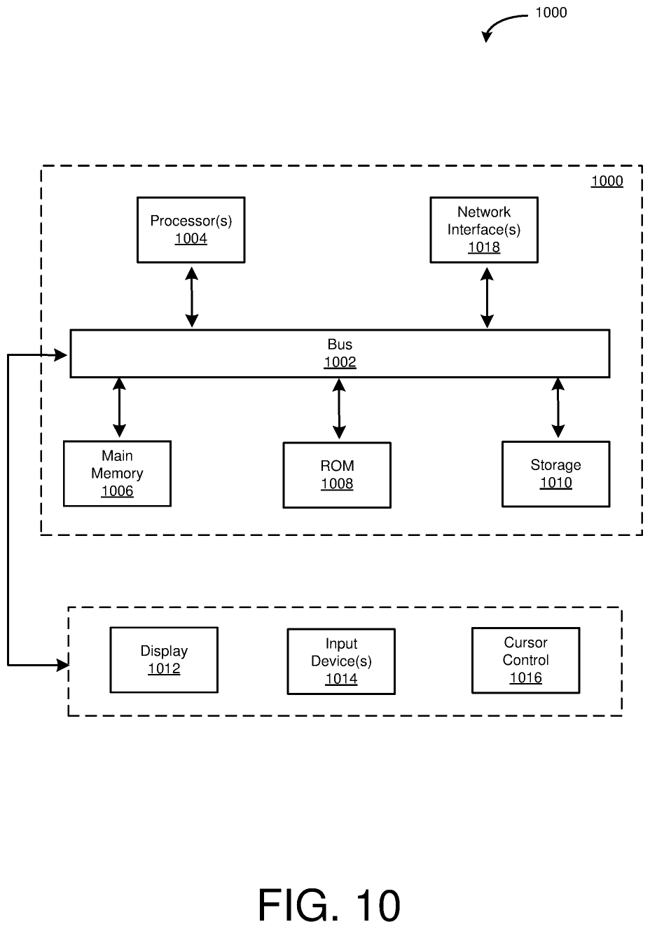

FIGS. 9A,B,C illustrate an example user interface 900 enabling a user to configure the rules for the process 500 of FIG. 5. Referring to FIG. 9A, a user has employed the user interface 900 to specify that a temporal vehicle repair benchmark is satisfied when a vehicle has spent more than 3 days in the vehicle repair facility, at 902. Referring to FIG. 9B, a user has employed the user interface 900 to specify that a temporal vehicle repair benchmark is satisfied when a vehicle has spent more than 5 days under repair in the vehicle repair facility, at 904. Referring to FIG. 9C, a user has employed the user interface 900 to specify that a temporal vehicle repair benchmark is satisfied only when a vehicle has spent more than 3 days in the vehicle repair facility, at 902 and the vehicle has spent more than 5 days under repair in the vehicle repair facility, at 904.

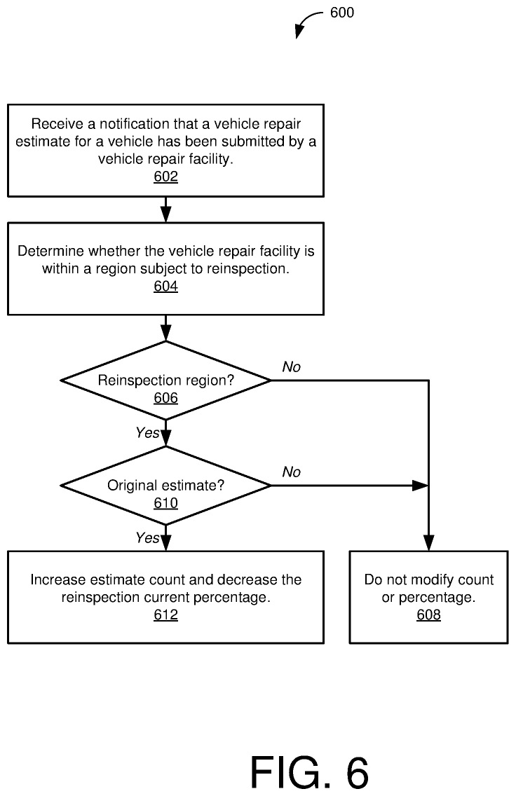

Some embodiments track and modify parameters such as estimate count, reinspection benchmark percentage, and the like. FIG. 6 illustrates a process 600 for tracking and modifying an estimate count and a reinspection benchmark percentage according to some embodiments of the disclosed technology. The process 600 may be performed, entirely or in part, by the vehicle repair reinspection tool 102 of FIG. 1.

Referring to FIG. 6, the process 600 may include receiving a notification that a vehicle repair estimate for a vehicle has been submitted by a vehicle repair facility, at 602, for example as described above. Responsive to receiving such a notification, the process 600 may include determining whether the vehicle repair facility is within a region subject to reinspection, at 604. Responsive to determining the vehicle repair facility is not within a region subject to reinspection, at 606, the process 600 may include leaving any count or percentage unmodified, at 608.

On the other hand, responsive to determining that the vehicle repair facility is within a region subject to reinspection, at 606, the process 600 may include determining whether the estimate is an original estimate, at 610. Only original estimates are counted in this process. Any supplemental estimates are not counted. Responsive to determining that the estimate is not an original estimate, at 610, the process 600 may include leaving any count or percentage unmodified, at 608.

On the other hand, responsive to determining that the estimate is an original estimate, at 610, the process 600 may include increasing the estimate count for the vehicle repair facility, and decreasing the reinspection current percentage, at 612.

FIG. 8B illustrates the example record 800 after modification responsive to receiving a notification of an original estimate for a vehicle repair facility in a reinspection region according to some embodiments of the disclosed technology. Referring to FIG. 8B, responsive to receiving notification of a new estimate from the vehicle repair facility, the count of the estimates submitted by the repair facility has been increased (to ESTIMATE_COUNT=11), and the percentage of the vehicles repaired by the repair facility that have been reinspected has been decreased (to REINSPECTION_PERCENT_CURRENT=9).

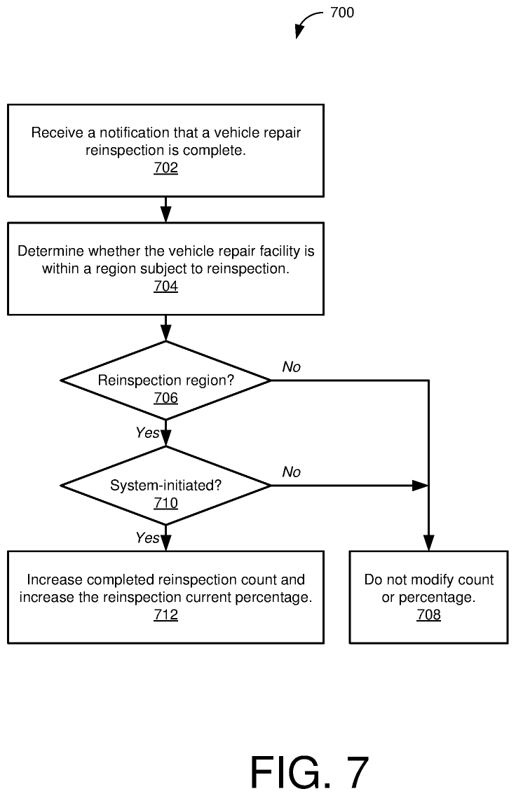

Some embodiments track and modify parameters such as completed reinspection count, reinspection benchmark percentage, and the like. FIG. 7 illustrates a process 700 for tracking and modifying an completed reinspection count and a reinspection benchmark percentage according to some embodiments of the disclosed technology. The process 700 may be performed, entirely or in part, by the vehicle repair reinspection tool 102 of FIG. 1.

Referring to FIG. 7, the process 700 may include receiving a notification that a vehicle repair reinspection is complete, at 702. Responsive to receiving such a notification, the process 700 may include determining whether the vehicle repair facility is within the region subject to reinspection, at 704. Responsive to determining the vehicle repair facility is not within a region subject to reinspection, at 706, the process 700 may include leaving any count or percentage unmodified, at 708.

On the other hand, responsive to determining that the vehicle repair facility is within a region subject to reinspection, at 706, the process 700 may include determining whether the reinspection was initiated by the vehicle repair reinspection system 100, at 710. In some cases, the reinspection may be initiated by other systems or manually. In these cases, the counts and percentages should not be modified. Responsive to determining that the reinspection was not initiated by the vehicle repair reinspection system 100, at 710, the process 700 may include leaving any count or percentage unmodified, at 708.

On the other hand, responsive to determining that the reinspection was initiated by the vehicle repair reinspection system 100, at 710, the process 700 may include increasing the estimate count for the vehicle repair facility, and decreasing the reinspection current percentage, at 712.

FIG. 8C illustrates the example record 800 after modification responsive to receiving a notification that a vehicle repair reinspection is complete according to some embodiments of the disclosed technology. Referring to FIG. 8C, responsive to receiving a notification that a vehicle repair reinspection is complete, the count of the reinspections completed at the repair facility has been increased (to COMPLETED_REINSPECTION_COUNT=2), and the percentage of the vehicles repaired by the repair facility that have been reinspected has been decreased (to REINSPECTION_PERCENT_CURRENT≈18).

Embodiments of the disclosed technology confer numerous benefits. The disclosed technology improves the quality of vehicle repairs by improving the manner of selection of vehicle repairs for reinspection. The disclosed technology requires little to no human involvement in deciding when to reinspect a vehicle repair. Manual tracking and reporting of reinspections is no longer required.

FIG. 10 depicts a block diagram of an example computer system 1000 in which embodiments described herein may be implemented. The computer system 1000 includes a bus 1002 or other communication mechanism for communicating information, one or more hardware processors 1004 coupled with bus 1002 for processing information. Hardware processor(s) 1004 may be, for example, one or more general purpose microprocessors.

The computer system 1000 also includes a main memory 1006, such as a random access memory (RAM), cache and/or other dynamic storage devices, coupled to bus 1002 for storing information and instructions to be executed by processor 1004. Main memory 1006 also may be used for storing temporary variables or other intermediate information during execution of instructions to be executed by processor 1004. Such instructions, when stored in storage media accessible to processor 1004, render computer system 1000 into a special-purpose machine that is customized to perform the operations specified in the instructions.

The computer system 1000 further includes a read only memory (ROM) 1008 or other static storage device coupled to bus 1002 for storing static information and instructions for processor 1004. A storage device 1010, such as a magnetic disk, optical disk, or USB thumb drive (Flash drive), etc., is provided and coupled to bus 1002 for storing information and instructions.

The computer system 1000 may be coupled via bus 1002 to a display 1012, such as a liquid crystal display (LCD) (or touch screen), for displaying information to a computer user. An input device 1014, including alphanumeric and other keys, is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. In some embodiments, the same direction information and command selections as cursor control may be implemented via receiving touches on a touch screen without a cursor.

The computing system 1000 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C, C++, and Python. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 1000 may implement the techniques described herein using customized hard-wired logic, one or more ASICs or FPGAs, firmware and/or program logic which in combination with the computer system causes or programs computer system 1000 to be a special-purpose machine. According to one embodiment, the techniques herein are performed by computer system 1000 in response to processor(s) 1004 executing one or more sequences of one or more instructions contained in main memory 1006. Such instructions may be read into main memory 1006 from another storage medium, such as storage device 1010. Execution of the sequences of instructions contained in main memory 1006 causes processor(s) 1004 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 1010. Volatile media includes dynamic memory, such as main memory 1006. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 1002. Transmission media can also take the form of acoustic or light waves, such as those generated during radio-wave and infra-red data communications.

The computer system 1000 also includes a communication interface 1018 coupled to bus 1002. Network interface 1018 provides a two-way data communication coupling to one or more network links that are connected to one or more local networks. For example, communication interface 1018 may be an integrated services digital network (ISDN) card, cable modem, satellite modem, or a modem to provide a data communication connection to a corresponding type of telephone line. As another example, network interface 1018 may be a local area network (LAN) card to provide a data communication connection to a compatible LAN (or a WAN component to communicate with a WAN). Wireless links may also be implemented. In any such implementation, network interface 1018 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 1018, which carry the digital data to and from computer system 1000, are example forms of transmission media.

The computer system 1000 can send messages and receive data, including program code, through the network(s), network link and communication interface 1018. In the Internet example, a server might transmit a requested code for an application program through the Internet, the ISP, the local network and the communication interface 1018.

The received code may be executed by processor 1004 as it is received, and/or stored in storage device 1010, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, or a combination of hardware and software. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 1000.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

1. A system, comprising:
a server computer comprising:
a hardware processor; and
a non-transitory machine-readable storage medium encoded with instructions executable by the hardware processor to perform a method comprising:
receiving, from a client device over a communications network, a notification that a vehicle repair estimate for a vehicle has been submitted by a vehicle repair facility;
responsive to receiving the notification, determining whether the vehicle repair facility has satisfied a quantitative vehicle repair re-inspection benchmark by:
determining a re-inspection current percentage of vehicles repaired by the repair facility that have been re-inspected, wherein the vehicle repair re-inspection benchmark comprises a re-inspection benchmark percentage,
comparing the re-inspection current percentage with the re-inspection benchmark percentage, and
determining whether the vehicle repair facility has satisfied the vehicle repair re-inspection benchmark based on the comparing;
responsive to determining the vehicle repair facility has not satisfied the vehicle repair re-inspection benchmark, determining whether the vehicle repair facility has satisfied a temporal vehicle repair benchmark for repair of the vehicle; and
responsive to determining the vehicle repair facility has satisfied the temporal vehicle repair benchmark for repair of the vehicle, initiating a re-inspection of the vehicle.

2. (canceled)

3. The system of claim 1, wherein determining whether the vehicle repair facility has satisfied the quantitative vehicle repair re-inspection benchmark based on the comparing comprises:
determining the vehicle repair facility has not satisfied the vehicle repair re-inspection benchmark when the re-inspection current percentage does not exceed the re-inspection benchmark percentage; and
determining the vehicle repair facility has satisfied the vehicle repair re-inspection benchmark when the re-inspection current percentage exceeds the re-inspection benchmark percentage.

4. The system of claim 1, wherein determining whether the vehicle repair facility has satisfied a temporal vehicle repair benchmark for repair of the vehicle comprises:
determining whether the vehicle has been at the vehicle repair facility for more than a first threshold time period, and/or
determining whether the vehicle has been under repair at the vehicle repair facility for more than a second threshold time period; and
determining the temporal vehicle repair benchmark has been satisfied responsive to determining that the vehicle has been at the vehicle repair facility for more than the first threshold time period and/or determining that the vehicle has been under repair at the vehicle repair facility for more than the second threshold time period.

5. The system of claim 1, the method further comprising:
responsive to receiving the notification, decreasing the re-inspection current percentage.

6. The system of claim 1, the method further comprising:
responsive to a re-inspection of the vehicle being completed, increasing the re-inspection current percentage.

7. The system of claim 1, the method further comprising:
determining whether the vehicle repair facility is within a region subject to re-inspection; and
responsive to the vehicle repair facility not being within a region subject to re-inspection, taking no action.

8. A non-transitory machine-readable storage medium encoded with instructions executable by a hardware processor of a server computer, the machine-readable storage medium comprising instructions to cause the hardware processor to perform a method comprising:
receiving, from a client device over a communications network, a notification that a vehicle repair estimate for a vehicle has been submitted by a vehicle repair facility;
responsive to receiving the notification, determining whether the vehicle repair facility has satisfied a quantitative vehicle repair re-inspection benchmark by:
determining a re-inspection current percentage of vehicles repaired by the repair facility that have been re-inspected, wherein the vehicle repair re-inspection benchmark comprises a re-inspection benchmark percentage,
comparing the re-inspection current percentage with the re-inspection benchmark percentage, and
determining whether the vehicle repair facility has satisfied the vehicle repair re-inspection benchmark based on the comparing;
responsive to determining the vehicle repair facility has not satisfied the vehicle repair re-inspection benchmark, determining whether the vehicle repair facility has satisfied a temporal vehicle repair benchmark for repair of the vehicle; and
responsive to determining the vehicle repair facility has satisfied the temporal vehicle repair benchmark for repair of the vehicle, initiating a re-inspection of the vehicle.

9. (canceled)

10. The non-transitory machine-readable storage medium of claim 8, wherein determining whether the vehicle repair facility has satisfied the quantitative vehicle repair re-inspection benchmark based on the comparing comprises:
determining the vehicle repair facility has not satisfied the vehicle repair re-inspection benchmark when the re-inspection current percentage does not exceed the re-inspection benchmark percentage; and
determining the vehicle repair facility has satisfied the vehicle repair re-inspection benchmark when the re-inspection current percentage exceeds the re-inspection benchmark percentage.

11. The non-transitory machine-readable storage medium of claim 8, wherein determining whether the vehicle repair facility has satisfied a temporal vehicle repair benchmark for repair of the vehicle comprises:
determining whether the vehicle has been at the vehicle repair facility for more than a first threshold time period, and/or
determining whether the vehicle has been under repair at the vehicle repair facility for more than a second threshold time period; and
determining the temporal vehicle repair benchmark has been satisfied responsive to determining that the vehicle has been at the vehicle repair facility for more than the first threshold time period and/or determining that the vehicle has been under repair at the vehicle repair facility for more than the second threshold time period.

12. The non-transitory machine-readable storage medium of claim 8, the method further comprising:
responsive to receiving the notification, decreasing the re-inspection current percentage.

13. The non-transitory machine-readable storage medium of claim 8, the method further comprising:
responsive to a re-inspection of the vehicle being completed, increasing the re-inspection current percentage.

14. The non-transitory machine-readable storage medium of claim 8, the method further comprising:
determining whether the vehicle repair facility is within a region subject to re-inspection; and
responsive to the vehicle repair facility not being within a region subject to re-inspection, taking no action.

15. A computer-implemented method comprising:
receiving, by a server computer from a client device over a communications network, a notification that a vehicle repair estimate for a vehicle has been submitted by a vehicle repair facility;
responsive to receiving the notification, determining, by the server computer, whether the vehicle repair facility has satisfied a quantitative vehicle repair re-inspection benchmark by:
determining a re-inspection current percentage of vehicles repaired by the repair facility that have been re-inspected, wherein the vehicle repair re-inspection benchmark comprises a re-inspection benchmark percentage,
comparing the re-inspection current percentage with the re-inspection benchmark percentage, and
determining whether the vehicle repair facility has satisfied the vehicle repair re-inspection benchmark based on the comparing;
responsive to determining the vehicle repair facility has not satisfied the vehicle repair re-inspection benchmark, determining, by the server computer, whether the vehicle repair facility has satisfied a temporal vehicle repair benchmark for repair of the vehicle; and
responsive to determining the vehicle repair facility has satisfied the temporal vehicle repair benchmark for repair of the vehicle, initiating, by the server computer, a re-inspection of the vehicle.

16. (canceled)

17. The computer-implemented method of claim 15, wherein determining whether the vehicle repair facility has satisfied the quantitative vehicle repair re-inspection benchmark based on the comparing comprises:
determining the vehicle repair facility has not satisfied the vehicle repair re-inspection benchmark when the re-inspection current percentage does not exceed the re-inspection benchmark percentage; and
determining the vehicle repair facility has satisfied the vehicle repair re-inspection benchmark when the re-inspection current percentage exceeds the re-inspection benchmark percentage.

18. The computer-implemented method of claim 15, wherein determining whether the vehicle repair facility has satisfied a temporal vehicle repair benchmark for repair of the vehicle comprises:
determining whether the vehicle has been at the vehicle repair facility for more than a first threshold time period, and/or
determining whether the vehicle has been under repair at the vehicle repair facility for more than a second threshold time period; and
determining the temporal vehicle repair benchmark has been satisfied responsive to determining that the vehicle has been at the vehicle repair facility for more than the first threshold time period and/or determining that the vehicle has been under repair at the vehicle repair facility for more than the second threshold time period.

19. The computer-implemented method of claim 15, further comprising:
responsive to receiving the notification, decreasing the re-inspection current percentage.

20. The computer-implemented method of claim 15, further comprising:
responsive to a re-inspection of the vehicle being completed, increasing the re-inspection current percentage.
